(19) United States
(12) Patent Application Publication
(10) Pub. No.: US 2012/0033945 A1
(43) Pub. Date: Feb. 9, 2012

(54) INFORMATION PLAYBACK APPARATUS, INFORMATION PLAYBACK METHOD, PROGRAM, INFORMATION RECORDING MEDIUM AND SEMICONDUCTOR INTEGRATED CIRCUIT

(75) Inventors: Masato KIHARA, Shiga (JP); Tsuyoshi Yoshii, Osaka (JP); Michiko Mizote, Osaka (JP)

(73) Assignee: PANASONIC CORPORATION, Osaka (JP)

(21) Appl. No.: 13/271,962

(22) Filed: Oct. 12, 2011

Related U.S. Application Data
(63) Continuation of application No. PCT/JP2009/006598, filed on Dec. 3, 2009.

(30) Foreign Application Priority Data
Jun. 11, 2009 (JP) 2009-139746

(51) Int. Cl. H04N 9/80

(52) U.S. Cl. 386/248; 386/E05.003

(57) ABSTRACT

A playback apparatus for playing back video data includes a read section and a control section, a first content includes first information and the first video data, a second content includes second information and second video data recorded in a different format from a format of the first video data, the first information is a part of management information for third video data recorded in a different format from the format of the first video data, the second information is a part of management information for the second video data, the read section reads out the first information and the second information from the first content and the second content, respectively, and outputs the first information and the second information to the control section, and when the first information and the second information match, the control section plays back the first video data.

### CROSS-REFERENCE TO RELATED APPLICATION

This is a continuation of PCT International Application PCT/JP2009/006598 filed on Dec. 3, 2009, which claims priority to Japanese Patent Application No. 2009-139746 filed on Jun. 11, 2009. The disclosures of these applications including the specifications, the drawings, and the claims are hereby incorporated by reference in their entirety.

### BACKGROUND

The present disclosure relates to techniques for information playback.

In recent years, various types of information recording mediums such as a Blu-ray disc (which will be hereinafter referred to as a BD), and a digital versatile disc (which will be hereinafter referred to as a DVD), etc. have been used. In many cases, the format of video data differs according to the type of an information recording medium. For example, when video data is recorded on a BD, a BD format is used, and when video data is written on a DVD, the DVD format is used. Also, even for information recording mediums of the same type, different formats might be used if the image quality of video data differs. Thus, under existing conditions, several different formats for video data are used.

According to a conventional technique described in International Publication No. WO2006/082892, a playback apparatus in which whether there is any relevance between two contents recorded in two information recording mediums of the same type is identified to control execution of an application has been known. In this case, video data contained in the two contents are in the same format.

### SUMMARY

However, according to the above-described conventional technique, it cannot be identified whether there is any relevance between contents having video data in different formats or not. This is because, according to the above-described conventional technique, when a first disc is switched to a second disc, a management table corresponding to a content of the first disc which was played back last is checked against a management table corresponding to a content of the second disc which is to be played back first. This checking is performed because it is assumed that the first and the second discs are in the same format.

It is therefore an object of the present disclosure to propose a technique for controlling playback of video data by identifying whether there is any relevance between contents having video data in different formats or not.

According to the present disclosure, an apparatus for playing back first video data includes a read section configured to read out information from an information recording medium, and a control section configured to control the read section, a first content includes first information and the first video data, a second content includes second information and second video data recorded in a different format from a format of the first video data, the first information is a part of management information for third video data recorded in a different format from the format of the first video data, the second information is a part of management information for the second video data, the read section reads out the first information and the second information from the first content and the second content, respectively, and outputs the first information and the second information to the control section, and when the first information and the second information match, the control section plays back the first video data.

According to the present disclosure, the first information read out from the first content and the second information read out from the second content are compared, thereby identifying whether there is any relevance between contents having video data in different formats or not, and when there is relevance between the contents, video data can be played back.

Preferably, the apparatus is configured so that, when the first information and the second information do not match, the control section does not play back the first video data.

With this configuration, whether there is any relevance between contents having video data in different formats can be identified, and when there is no relevance between the contents, video data can be caused not to be played back.

Preferably, the apparatus is configured so that, when the second video data and the third video data are the same, the first information and the second information match.

With this configuration, when the second video data and the third video data are the same, the first video data can be played back.

Preferably, the apparatus is configured so that, the first video data has higher image quality than image quality of the second video data.

With this configuration, the first information read out from the first content and the second information read out from the second content are compared, thereby identifying whether there is any relevance between contents having video data in different formats or not, and when there is relevance between the contents, higher quality video data can be played back.

Preferably, the apparatus is configured so that, the first content and the second content are recorded in a first information recording medium and a second information recording medium, respectively.

With this configuration, whether there is any relevance between contents having video data recorded in different formats in different information recording mediums can be identified, and when there is relevance between the contents, video data can be played back.

Preferably, the apparatus is configured so that the control section includes a recording section.

With this configuration, information can be recorded in the control section.

Preferably, the apparatus is configured so that when the first information and the second information match, the control section records, in the recording section, playback allowance information indicating that playback of the first video data is allowed.

With this configuration, the playback allowance information indicating that playback of the first video data is allowed can be recorded in the recording section.

Preferably, the apparatus is configured so that when the playback allowance information is recorded in the recording section, the control section controls the read section so that the read section does not read out the first information and the second information, and plays back the first video data.

With this configuration, when the playback allowance information is recorded in the recording section, reading-out of the first information and the second information can be omitted.

Preferably, the apparatus is configured so that the control section records the second information in the recording section.

With this configuration, the second information can be recorded in the recording section.

Preferably, the apparatus is configured so that the read section reads out the first information from the first content, and outputs the first information to the control section, and when the first information and the second information recorded in the recording section match, the control section controls the read section so that the read section does not read out the second information from the second content, and plays back the first video data.

With this configuration, when the first information and the second information recorded in the recording section match, the first video data can be played back without reading out the second information from the second content.

Preferably, the apparatus is configured so that the first content and the second content are recorded in a first information recording medium and a second information recording medium, respectively.

With this configuration, when the first information and the second information recorded in the recording section match, the first video data can be played back without reading out the second information from the second content.

As described above-described, according to the present disclosure, the first information read out from the first content and the second information read out from the second content are compared, thereby identifying whether there is any relevance between the contents having video data in different formats or not, and when there is relevance between the contents, video data can be played back.

### BRIEF DESCRIPTION OF THE DRAWINGS

FIG. 1 is a block diagram illustrating a configuration of a playback apparatus according to an embodiment.

FIG. 2 is a block diagram illustrating an example of information which can be used in an information comparison step according to the embodiment.

FIG. 3 is a block diagram illustrating another example of information which can be used in the information comparison step.

FIG. 4 is a block diagram illustrating a still another example of information which can be used in the information comparison step.

FIG. 5 is a flowchart illustrating a playback method according to a first embodiment.

FIG. 6 is a flowchart illustrating a playback method according to a second embodiment.

FIG. 7 is a flowchart illustrating a playback method according to a third embodiment.

FIG. 8 is a flowchart illustrating a playback method according to a variation of the third embodiment, when content having SD image quality is recorded in a HD.

FIG. 9 is a flowchart illustrating a playback method according to a fourth embodiment.

### DETAILED DESCRIPTION

What is common to embodiments will be described below. Note that the present disclosure is not limited to the following embodiments.

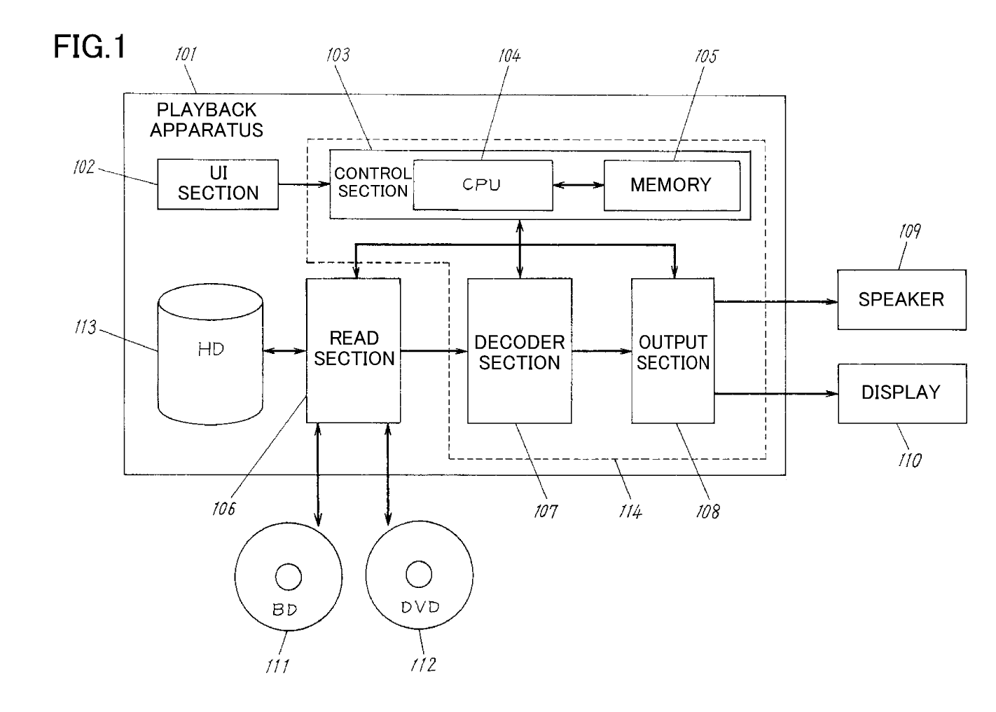

An example playback apparatus according to the present disclosure is shown in FIG. 1. A playback apparatus 101 includes a user interface (which will be hereinafter referred to as a “UI”) section 102, a control section 103 including a central processing unit (which will be hereinafter referred to as a “CPU”) 104 and a memory 105, etc., a read section 106, a decoder section 107, and an output section 108. A speaker 109 and a display 110 form a video display apparatus such as a plasma TV, and a liquid crystal TV, etc. Information recording mediums 111, 112, and 113 are physically different information recording mediums. In the following embodiments, the information recording medium 111 is a BD, the information recording medium 112 is a DVD, and the information recording medium 113 is a hard disk (which will be hereinafter referred to as a “HD”). The HD 113 is in general provided in the playback apparatus 101, but may be externally attached to the playback apparatus 101. The control section 103, the decoder section 107, and the output section 108 are included in a semiconductor integrated circuit 114.

The UI section 102 includes, for example, an operational tool such as a key board, a button, and a remote controller, etc., and an input control circuit configured to generate a signal according to an input operation using the operational tool and output the signal to the control section 103, etc.

The control section 103 controls an overall operation of the playback apparatus 101. For example, the control section 103 instructs the read section 106 to read out information recorded in the information recording mediums 111, 112, and 113, and output the read-out information to the control section 103 or the decoder section 107. The control section 103 also controls the decoder section 107 and the output section 108, etc.

The CPU 104 and the memory 105 form the control section 103. The memory (recording section) 105 includes a read only memory in which a program and data, etc. required for an operation of the control section 103 are stored, and a random access memory which the CPU 104 utilizes as a work region.

The read section 106 includes a pickup control section and a machine control section, etc., and reads out contents recorded in the information recording mediums 111, 112, and 113, etc. according to a signal from the control section 103. Each content includes video data, and management information for the video data, etc. The content might further include a program, etc. The video data read out by the read section 106 is output from the read section 106 to the decoder section 107. The management information for the video data, and the program, etc. are output from the read section 106 to the control section 103. The control section 103 instructs the decoder section 107 to perform decoding according to a format of the video data. The decoder section 107 decodes video data to digital data according to the instruction of the control section 103, and outputs the digital data to the output section 108. The output section 108 digital-to-analog converts the digital data, and outputs the analog data to the speaker 109 and the display 110. The program is executed in the control section 103.

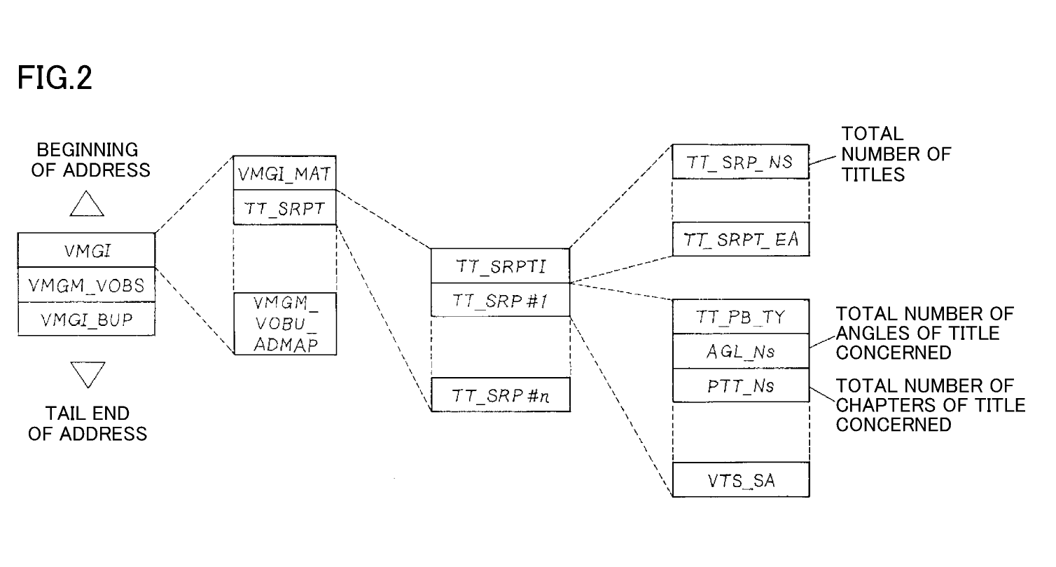

The management information herein means information for a format and configuration, etc. of video data. Specifically, it includes titles of video data, the total number of titles, the total number of angles of a title concerned, the total number of chapters of a title concerned, the total number of sound streams, the total number of subtitle streams, an entire playback time for the titles, and user's operations inhibited by the titles, etc. Examples of the management information when video data is recorded in a DVD format are shown in FIGS. 2, 3, and 4.

In FIG. 2, information for a VIDEO_TS directory is stored in video manager information (VMGI) included in management information for video data recorded in the DVD format. VMGI includes a video manager information management table (VMG_MAT) and a title search pointer table (TT_SRPT), etc. In TT_SRPT, title search pointer table information (TT_SRPTI), and a title search pointer (TT_SRP#n) for a title #n, to which a title number from 1 to 99 is given, are described. In TT_SRP_NS included in TT_SRPTI, the number of the title search pointers, i.e., the total number of titles is described. For example, in the information included in TT_SRP#n, AGL_Ns is information for the total number of angles of a title concerned, and PTT_Ns is information for the total number of chapters in a title concerned.

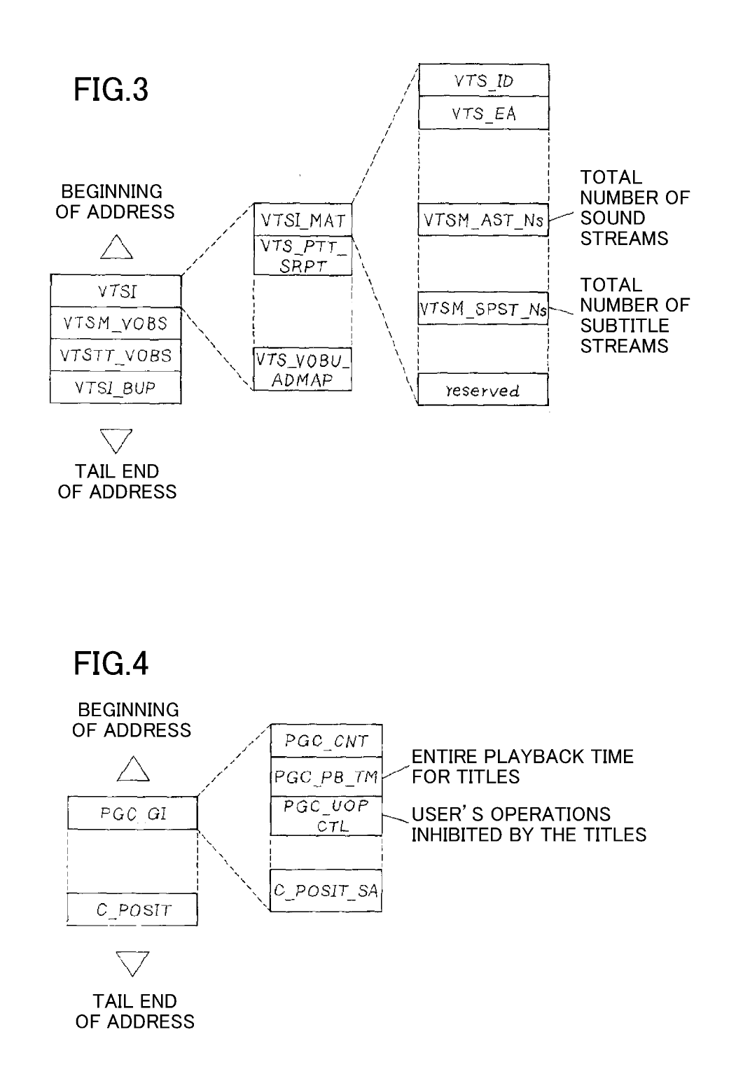

In FIG. 3, information for one or more video titles and a video title set menu (VTSM) is stored in video title set information (VTSI) included in management information for video data recorded in the DVD format. VTSI includes a video title set information management table (VTSI_MAT) and a video title set PTT search pointer table (VTS_PTT_SRPT), etc. VTSM_AST_Ns and VTSM_SPST_Ns of information included in VTSI_MAT are information for the total number of sound streams for VTSM and information for the total number of subtitle streams of content in a video title set, respectively.

In FIG. 4, program chain general information (PGC_GI) included in management information for video data recorded in the DVD format is used to control playback of a program chain (PGC). PGC_PB_TM and PGC_UOP_CTL of information included in PGC_GI are information for an entire playback time for titles of PGC and user's operations prohibited by the titles during PGC playback, respectively.

In embodiments described below, a first content includes first video data and first information, a second content includes second video data and second information. The second video data is recorded in a different format from a format of the first video data. The first information is a part of management information for third video data recorded in a different format from the format of the first video data, and the second information is a part of management information for the second video data. When the different format from the format of the first video data is the DVD format, information having one of the management information configurations of FIGS. 2, 3, and 4, or information having a combination of more than one of the management information configurations of the FIGS. 2, 3, and 4 can be used as a part of management information. For example, one or a combination of more than one of titles of video data, the total number of titles, the total number of angles of a title concerned, the total number of chapters of a title concerned, the total number of sound streams, the total number of subtitle streams, an entire playback time for the titles, and user's operations prohibited by the titles, etc. can be used, but a part of management information according to the present disclosure is not limited to the above-described examples. Note that when the second video data and the third video data are the same, the first information and the second information are set so that the first information and the second information match.

### First Embodiment

In a first embodiment, a first content is recorded on the BD 111, and a second content is recorded on the DVD 112. The first content includes a program as well as first video data and first information, and the second content includes second video data and second information. The first video data is video data (which will be hereinafter referred to as “ABC_BD”) of a movie “ABC” recorded in the BD format. The first information is a part of management information for third video data, and the third video data is video data (which will be hereinafter referred to as “ABC_DVD”) of the movie “ABC” recorded, for example, in the DVD format, which is a different format from the format of the first video data. That is, in the first embodiment, the first video data and the third video data are video data of a movie having the same title, but the first video data is recorded in the BD format, and the third video data is recorded in the DVD format. Assuming the above, the first information is a part of management information for the third video data ABC_DVD. The program included in the first content is a Java (registered trademark) application program. In the first embodiment, when the first information and the second information match, ABC_BD is played back. That is, if the second video data is ABC_DVD, the first information and the second information match, and therefore, ABC_BD is played back. If the second video data is not ABC_DVD, the first information and the second information do not match, and therefore, ABC_BD is not played back.

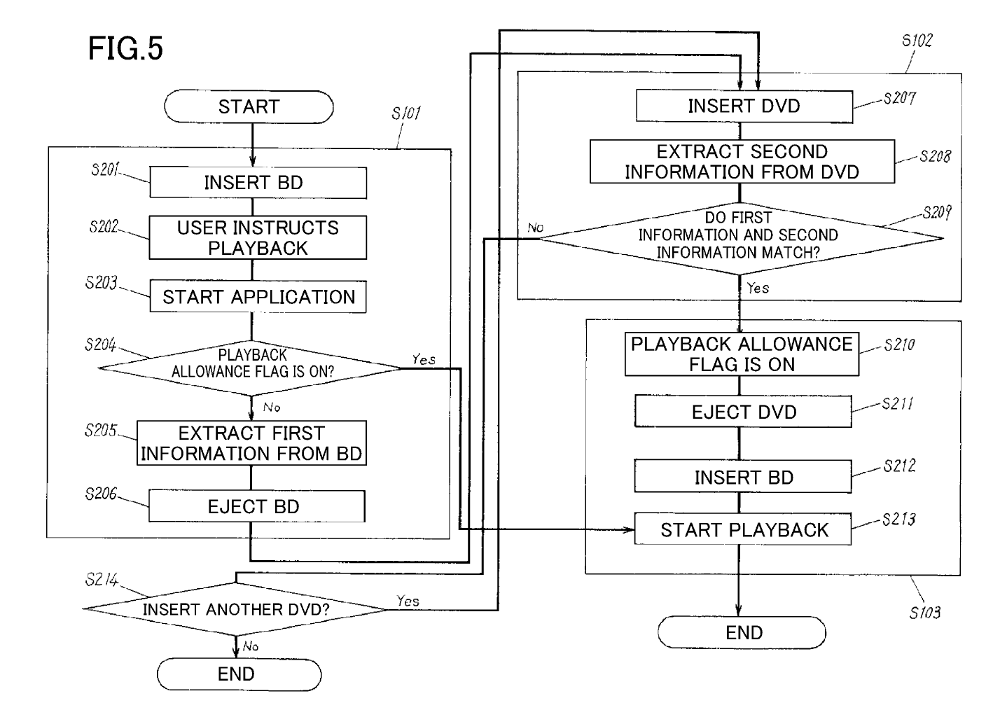

A method for playing back the first video data ABC_BD of the movie ABC recorded in the BD format according to the first embodiment will be described with reference to a flowchart of FIG. 5. Note that steps of the playback method shown by the flowchart of FIG. 5 may be recorded in an information recording medium.

The playback method of the first embodiment includes an information extraction step S101, an information comparison step S102, and a playback allowance step S103. Each of the steps will be described below.

In the information extraction step S101, the read section 106 reads out the first information from the first content recorded on the BD 111, and outputs the first information to the control section 103.

Specifically, first, a user inserts the BD 111 into the read section 106 in a step S201, and the user instructs the control section 103 to play back ABC_BD recorded on the BD 111 from the UI section 102 in a step S202. Note that there might be cases where user's instruction is not necessary, and the control section 103 determines that playback video data is instructed by inserting the BD 111.

In a step S203, a Java (registered trademark) application is started in the control section 103. In response to the instruction of playback in the step S202, the read section 106 reads out the Java (registered trademark) application program recorded on the BD 111 and outputs the program to the control section 103. In the control section 103, the Java (registered trademark) application program is stored in the memory 105, and the Java (registered trademark) application program starts operating. The Java (registered trademark) application is a disc unbound application (which will be hereinafter referred to as “DUBA”) which can continuously operate in the playback apparatus 101 even after the BD 111 is ejected from the playback apparatus 101. Note that the Java (registered trademark) application program may be a program which has been stored in the memory 105 of the playback apparatus 101 in advance. In that case, in response to the instruction of playback in the step S202, the Java (registered trademark) application program starts operating.

In a step S204, the control section 103 which has received the instruction of the Java (registered trademark) application checks whether playback of ABC_BD has been allowed or not. For example, in the first embodiment, when playback of ABC_BD is allowed, information that “a playback allowance flag (playback allowance information) for ABC_BD is on” is recorded in the memory 105 of the control section 103. When playback of ABC_BD is not allowed, the information that “a playback allowance flag for ABC_BD is on” is not recorded in the memory 105 of the control section 103. This state will be referred to as a state where the playback allowance flag is off” In the step S204, the control section 103 refers to the memory 105 and checks whether the playback allowance flag is on or off.

If the playback allowance flag is on, playback of a step S213 is immediately started. That is, in the step S213, the control section 103 controls the read section 106 so that the read section 106 does not perform read-out of the first information of a step S205 and read-out of the second information of a step S208, and controls the playback apparatus 101 so that the playback apparatus 101 plays back ABC_BD recorded on the BD 111. For example, the control section 103 issues an instruction to play back ABC_BD recorded on the BD 111 to the read section 106, the decoder section 107, and the output section 108, etc.

If the playback allowance flag is off, the step S205 is executed. In the step S205, the control section 103 which has received the instruction of the Java (registered trademark) application controls the read section 106 so that the read section 106 reads out the first information from the BD 111 and outputs the first information to the control section 103. The first information output to the control section 103 is stored in the memory 105.

In a step S206, the control section 103 which has received the instruction of the Java (registered trademark) application issues an instruction to eject the BD 111 to the read section 106. In response to the instruction, the read section 106 ejects the BD 111. Alternatively, the control section 103 may operate the speaker 109 and the display 110 to issue an instruction to eject the BD 111 from the read section 106 to the user. The Java (registered trademark) application is DUBA, and continuously operates in the control section 103 even after the BD 111 has been ejected. The control section 103 may be configured to cause the display 110 to display an instruction for user's next operation, indicating, for example, “Please insert DVD.”

In an information comparison step S102, the read section 106 reads out the second information from the second content recorded on the DVD 112 and outputs the second information to the control section 103, and the control section 103 compares the first information and the second information.

Specifically, in a step S207, the user inserts the DVD 112 into the read section 106 of the playback apparatus. In this case, the Java (registered trademark) application does not have to play back the second information recorded on the DVD 112.

In a step S208, the control section 103 which has received the instruction of the Java (registered trademark) application controls the read section 106, and the read section 106 outputs the second information from the second content recorded on the DVD 112 to the control section 103. In this case, if the second video data is ABC_DVD, which is the same as the third video data, information corresponding to the first information read out in the step S205 is read out as the second information so that the first information and the second information match. For example, when the title ABC_DVD is used as the first information, the titles of the second video data are read out, as the second information, from the second content recorded on the DVD 112. When a combination of the entire playback time for titles and the total number of the titles is used as the first information, the entire playback time for titles of the second video data and the total number of the titles of the second video data are read out from the second content recorded on the DVD 112. The read section 106 outputs the read out second information to the control section 103.

In a step S209, the control section 103 which has received the instruction of the Java (registered trademark) application compares the second information read out in the step S208 and the first information read out in the step S205. For example, when the titles of video data is used as the first information and the second information, the title ABC_DVD in the first information is compared to a title of the second video data read out as the second information. If they are the same, it is determined that the first information and the second information match. When a combination of the entire playback time for titles and the total number of titles is used as the first information and the second information, it is determined, if the entire playback time for titles of ABC_DVD and the entire playback time for titles in the second video data read out as the second information are the same, that the first information and the second information match.

As a result of the comparison of the step S209, when the first information and the second information match, the playback allowance step S103 is executed.

As a result of the comparison of the step S209, when the first information and the second information do not match, the playback allowance flag remains off. That is, the control section 103 controls the playback apparatus 101 so that the playback apparatus 101 does not play back ABC_BD. Then, in a step S214, the user determines whether to insert another DVD or not, and inputs a result of the determination via the UI section 102. In this case, the control section 103 may be configured to cause the display 110 to display a message “Do you want to insert another DVD?” The UI section 102 outputs a signal corresponding to the input of the user to the control section 103. If the user inserts another DVD, the Java (registered trademark) application continuously operates. Then, the process returns to the step S207, and the user inserts a different DVD into the read section 106. If the user does not want to insert another DVD, the Java (registered trademark) application is halted. The user can also view the DVD 112 inserted in the steps S207.

In the playback allowance step S103, ABC_BD recorded on the BD 111 inserted in the step S201 is played back.

Specifically, in a step S210, in response to the instruction of the Java (registered trademark) application, the control section 103 turns on a playback allowance flag to allow playback of ABC_BD recorded on the BD 111 inserted in the step S201. For example, in the first embodiment, the control section 103 records information that the playback allowance flag for ABC_BD is on in the memory 105.

In the step S211, the control section 103 issues an instruction to eject the DVD 112 to the read section 106, and the read section 106 ejects the DVD 112. Note that the control section 103 may operate the speaker 109 and the display 110 to instruct the user to eject the DVD 112 from the read section 106. Even after the DVD 112 is ejected, the Java (registered trademark) application continuously operates. The display 110 may be configured to display an instruction for user's next operation indicating, for example, “Please insert BD.”

In a step S212, the user inserts again the BD 111 inserted in the step S201 into the read section 106 of the playback apparatus 101. When the BD 111 inserted in the step S201 is inserted into the read section 106 and the control section 103 recognizes the BD 111, a step S213 is executed. The BD which is to be inserted may be a physically different BD from the BD 111 inserted in the step S201, as long as a content recorded on the BD is the same as the content of the BD 111 inserted in the step S201. In this case, if a BD in which a different content is recorded is inserted, the Java (registered trademark) application is halted, and the user can view video data of the different content.

In the step S213, according to the instruction of the Java (registered trademark) application, the control section 103 issues an instruction to play back ABC_BD recorded on the BD 111 to the read section 106, the decoder section 107, and the output section 108. That is, the control section 103 controls the playback apparatus 101 to play back ABC_BD recorded on the BD 111.

According to the first embodiment, the first content including the BD version of the movie ABC includes the management information for the DVD version of the movie ABC as the first information, and the playback apparatus compares the first information and the second information of the second content, thereby identifying whether there is any relevance between the contents having video data in different formats or not. Using this technique, the playback apparatus can allow playback of the BD version of the movie ABC with the recognition of the existence of the DVD version of the movie ABC.

In recent years, as high-definition televisions have become widely used, content publishers not only record new content on BDs and sell them, but also re-release content which has been sold in the past in the DVD format in the BD format. However, for users who have purchased DVDs in the past, it is a burden to purchase BDs with the same content, and the users hesitate to purchase. Using the technique of the first embodiment, content publishers can inexpensively provide BD content which only users who have purchased DVDs with the same content in the past are allowed to play back. Thus, content publishers can promote the sales of BDs, and users can purchase a BD version of the same content at a lower price than an initial purchase price.

### Second Embodiment

In a second embodiment, a first content is obtained from a network, etc. and recorded in the HD 113, and a second content is recorded on the DVD 112. The first content includes a program as well as first video data and first information, and the second content includes second video data and second information. The first video data is video data (which will be hereinafter referred to as “ABC_BD”) of a movie “ABC” recorded, for example, in the BD format, which is a different format from the DVD format. The first information is a part of management information for third video data, and the third video data is video data (which will be hereinafter referred to as “ABC_DVD”) of the movie “ABC” recorded in the DVD format. That is, in the second embodiment, the first video data and the third video data are video data of a movie having the same title, but the first video data is recorded in the BD format, and the third video data is recorded in the DVD format. Assuming the above, the first information is a part of management information for the third video data ABC_DVD. The program included in the first content may be a Java (registered trademark) application program, or may be another application program. In the second embodiment, when the first information and the second information match, ABC_BD is played back. That is, if the second video data is ABC_DVD, the first information and the second information match, and therefore, ABC_BD is played back. If the second video data is not ABC_DVD, the first information and the second information do not match, and therefore, ABC_BD is not played back.

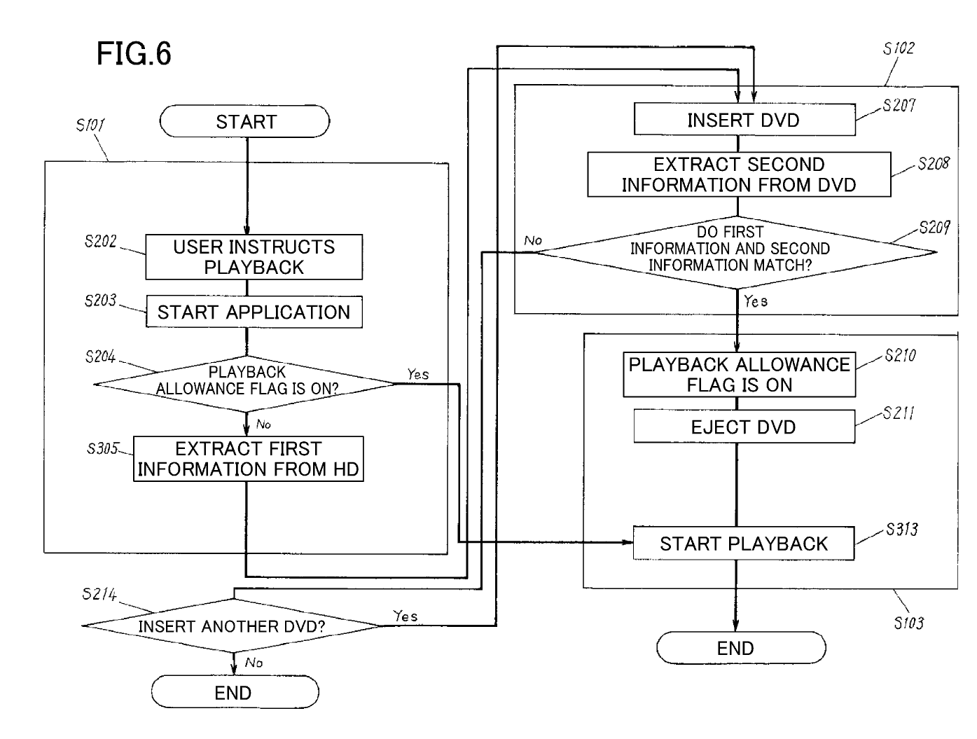

The second embodiment can be shown by the flowchart of FIG. 6. Each step also shown in FIG. 5 in the first embodiment is identified by the same reference character, and the description thereof will be omitted. Insertion and extraction of a BD in the steps S201, S206, and S212 of FIG. 5 are not necessary because the first content is recorded in the HD 113. Also, the first information is recorded in the HD 113. Thus, when a playback allowance flag is not on in the step S204, in a step S305, the first information is read out from the HD 113, and the first information is output to a control section 103.

The playback method according to the second embodiment includes an information extraction step S101, an information comparison step S102, and a playback allowance step S103. Each of the steps will be described below.

In the information extraction step S101, the read section 106 reads out the first information from the first content recorded in the HD 113, and outputs the first information to the control section 103.

In the step S204, the control section 103 which has received an instruction of the application checks whether playback of a content with high definition image quality has been allowed or not. For example, the control section 103 checks whether the playback allowance flag recorded in the memory 105 of the control section 103 is on or off.

If the playback allowance flag is on, playback of a step S313 is immediately started. If the playback allowance flag is off, the step S305 is executed. In the step S305, the control section 103 which has received the instruction of the application controls the read section 106 so that the read section 106 reads out the first information from the HD 113 and outputs the first information to the control section 103. The first information output to the control section 103 is stored in the memory 105.

The information comparison step S102 is the same as that of the first embodiment.

In the playback allowance step S103, ABC_BD recorded in the HD 113 is played back. The step S211 can be omitted. In the step S313, the application issues an instruction to play back ABC-BD recorded in the HD 113 to the read section 106, the decoder section 107, and the output section 108, and playback of the HD 113 is started.

According to the second embodiment, the first content including the high definition version of the movie ABC includes the management information for the DVD version of the movie ABC as the first information, and the playback apparatus compares the first information and the second information of the second content, thereby identifying whether there is any relevance between the contents having video data in different formats or not. Using this technique, the playback apparatus can allow playback of a high definition version of the movie ABC provided over the network, etc. with the recognition of the existence of the DVD version of the movie ABC. Using this technique, content publishers can inexpensively provide high definition content which only users who have purchased DVDs with the same content in the past are allowed to play back. Thus, the content publishers can promote the sales of the high definition content, and users can purchase a high definition version of the same content at a lower price than an initial purchase price.

### Third Embodiment

In a third embodiment, a first content is recorded on the BD 111, and a second content is obtained from a network, etc. and recorded in the HD 113. The first content includes a program as well as first video data and first information, and the second content includes second video data and second information. The first video data is video data (which will be hereinafter referred to as “ABC_BD”) of a movie “ABC” recorded in the BD format. The first information is a part of management information for third video data, and the third video data is video data (which will be hereinafter referred to as “ABC_DVD”) of the movie “ABC” recorded, for example, in the DVD format, which is a different format from the format of the first video data. That is, in the third embodiment, the first video data and the third video data are video data of a movie having the same title, but the first video data is recorded in the BD format, and the third video data is recorded in the DVD format. Assuming the above, the first information is a part of management information for the third video data ABC_DVD. The program included in the first content is a Java (registered trademark) application program. In the third embodiment, when the first information and the second information match, ABC_BD is played back. That is, if the second video data is ABC_DVD, the first information and the second information match, and therefore, ABC_BD is played back. If the second video data is not ABC_DVD, the first information and the second information do not match, and therefore, ABC_BD is not played back.

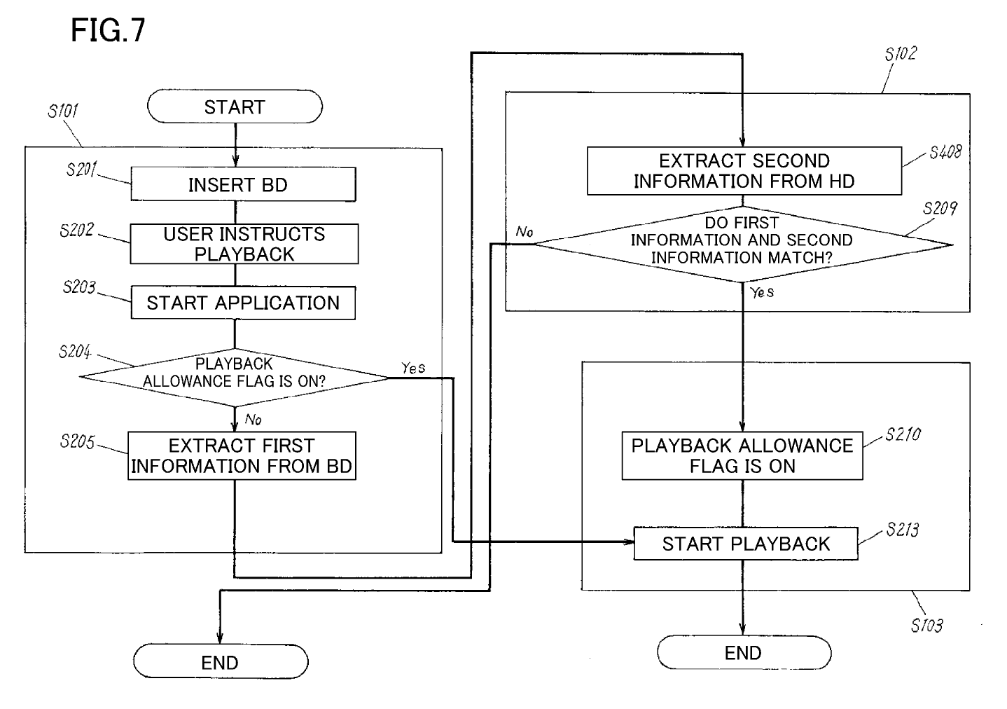

The third embodiment can be shown by the flowchart of FIG. 7. Each step also shown in FIG. 5 in the first embodiment and FIG. 6 in the second embodiment is identified by the same reference character, and the description thereof will be omitted. As opposed to the first embodiment, the steps S207 and S211 in which a DVD of FIG. 2 is inserted/ejected are not necessary. Accordingly, the steps S206 and S212 in which a BD is inserted/ejected are also not necessary.

In the information extraction step S101, the step S206 is not necessary.

In the information comparison step S102, the read section 106 reads out the second information from the second content recorded in the HD 113 and outputs the second information to the control section 103, and the control section 103 compares the first information and the second information.

In a step S408, the control section 103 which has received an instruction of the Java (registered trademark) application reads out the second information from the second content recorded in the HD 113.

In the playback allowance step S103, ABC_BD recorded on the BD 111 inserted in the step S201 is played back.

According to the third embodiment, the first content including the BD version of the movie ABC includes the management information for the low definition version of the movie ABC as the first information, and the playback apparatus compares the first information and the second information of the second content, thereby identifying whether there is any relevance between the contents having video data in different formats or not. Using this technique, the playback apparatus can allow playback of the movie ABC recorded on the BD with the recognition of the existence of the low definition version of the movie ABC recorded in the HD. Using this technique, content publishers can inexpensively provide BDs which only users who have purchased the low definition version of the same content over the network, etc. in the past are allowed to play back. Thus, the content publishers can promote the sales of BDs, and users can purchase a BD version of the same content at a lower price than an initial purchase price.

(Variation of Third Embodiment)

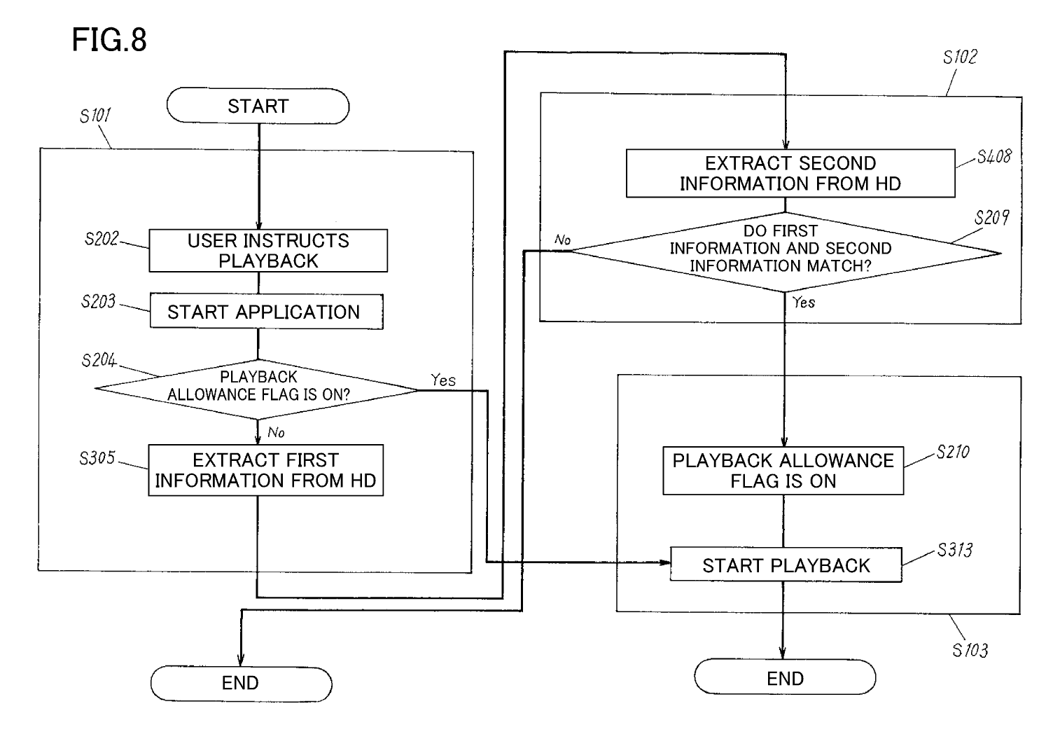

In the third embodiment, the first content is recorded on the BD 111. However, the first content may be obtained from a network, etc. and recorded in the HD 113, as in the second embodiment. FIG. 8 shows a flowchart of a playback method in such a case.

In this variation, the first content including the high definition version of the movie ABC includes the management information for the low definition version of the movie ABC as the first information, and the playback apparatus compares the first information and the second information of the second content. Thus, whether there is any relevance between the contents having video data in different formats or not can be identified. According to this technique, the playback apparatus can allow playback of a high definition version of the movie ABC provided over the network, etc. with the recognition of the existence of the low definition version of the movie ABC recorded in the HD.

Using this technique, content publishers can inexpensively provide over the network, etc. a high definition version of content which only users who have purchased a low definition version of the same content over the network, etc. and recorded the content in HDs in the past are allowed to play back. Thus, the content publishers can promote the sales of high definition content, and users can purchase the same content at a lower price than an initial purchase price.

### Fourth Embodiment

In a fourth embodiment, a first content is recorded on the BD 111, and a second content is recorded on the DVD 112. The first content includes a program as well as first video data and first information, and the second content includes second video data and second information. The first video data is video data (which will be hereinafter referred to as “ABC_BD”) of a movie “ABC” recorded in the BD format. The first information is a part of management information for third video data, and the third video data is video data (which will be hereinafter referred to as “ABC_DVD”) of the movie “ABC” recorded, for example, in the DVD format, which is a different format from the format of the first video data. That is, in the fourth embodiment, the first video data and the third video data are video data of a movie having the same title, but the first video data is recorded in the BD format, and the third video data is recorded in the DVD format. Assuming the above, the first information is a part of management information for the third video data ABC_DVD. The program included in the first content is a Java (registered trademark) application program. In the fourth embodiment, when the first information and the second information match, ABC_BD is played back. That is, if the second video data is ABC_DVD, the first information and the second information match, and therefore, ABC_BD is played back. If the second video data is not ABC_DVD, the first information and the second information do not match, and therefore, ABC_BD is not played back.

According to the fourth embodiment, when a user plays back video data in the DVD format for the first time, a part of management information for the video data is stored as the second information in a memory 105, and the first information read from the ABC_BD recorded on the BD 111 and each of multiple ones of the second information stored in the memory 105 are compared. When the second information which matches the first information is found, ABC_BD recorded on the BD 111 is played back. This playback method of the fourth embodiment will be described.

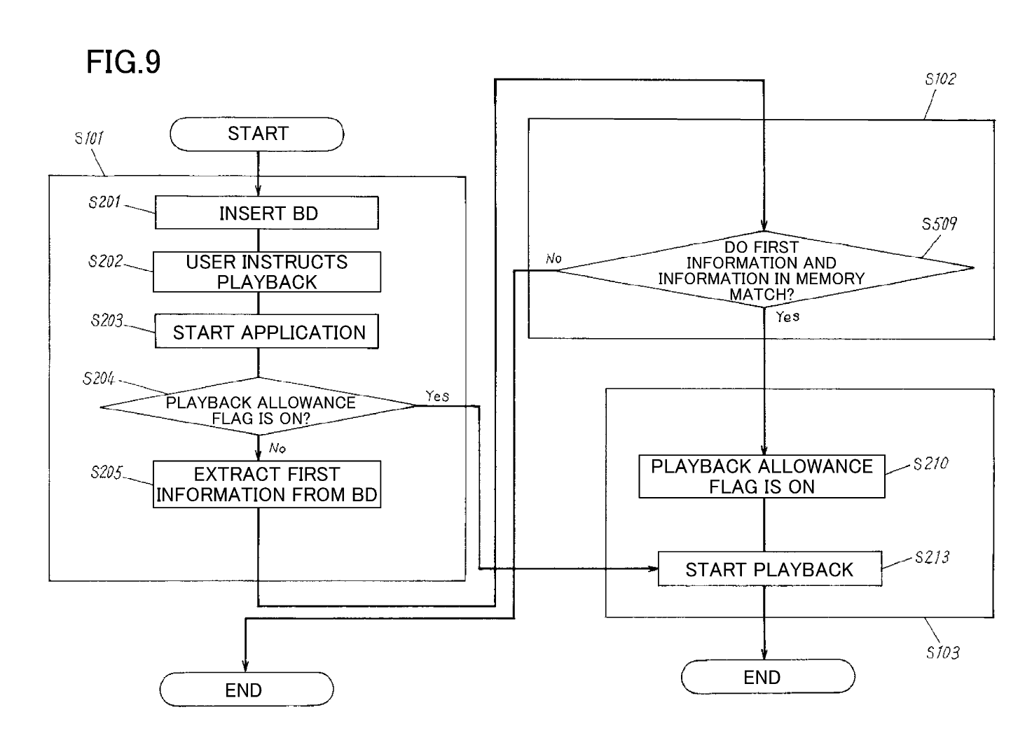

The fourth embodiment will be described with reference to a flowchart of FIG. 9. Each step also shown in FIG. 5 in the first embodiment is identified by the same reference character, and the description thereof will be omitted.

In the information extraction step S101, as compared with the first embodiment, the step S206 can be omitted.

In the information comparison step S102, as compared with the first embodiment, the step S207 and the step S208 can be omitted. In a step S509, the first information and the second information stored in the memory 105 are compared. If multiple ones of the second information are stored, the multiple ones of the second information are compared to the first information one after another. In this step, comparison between the first information and the second information may be performed such that a part of the first information and a part of each of the multiple ones of the second information are compared to select one of the multiple ones of the second information which has a part matching the part of the first information, and then, an entire part of the first information and an entire part of the selected second information are compared. If any one of the multiple ones of the second information recorded in the memory 105 matches the first information, a playback allowance flag is turned on in the step S210. If none of the multiple ones of the second information matches the first information, playback continues to be prohibited.

In the reproduction allowance step S103, as compared with the first embodiment, the step S211 and the step S212 can be omitted.

As described above, in the fourth embodiment, in addition to the advantages of the first embodiment, the step S206 of ejecting the BD111, the step S207 of inserting a DVD, the step S208 of extracting the second information from the DVD, the step S211 of ejecting the DVD, and the step S212 of inserting the BD can be omitted.

Note that in the above-described embodiments, the playback apparatus of FIG. 1 is used, but a playback apparatus according to the present disclosure is not limited thereto.

An information recording medium according to the present disclosure is not limited to the BD 111, the DVD 112, and the HD 113. For example, any information recording medium such as an SD card, and a large capacity optical disc with a larger capacity than that of a BD, which is expected to be developed in future, etc. can be used.

The semiconductor integrated circuit 114 may be made of a signal chip, or a group of a plurality of chips.

Examples of management information are shown in FIGS. 2, 3, and 4. The examples shown in FIGS. 2, 3, and 4 are merely examples of management information for video data recorded in the DVD format, and management information according to the present disclosure is not limited thereto.

The first content, the second content, the first video data, the second video data, the third video data, the first information, the second information, and the program are not limited to the examples described in the above embodiments. The first video data and the third video data do not have to be video data of a movie having the same title, but may be two video data which are desired to be associated with each other. The first video data does not have to be in the BD format and the third video data does not have to be in the DVD format. There may be a case where the first video data is in a format having a higher definition than that of the BD format, and the third video data is in the BD format.

A method for checking whether playback is allowed or not is not limited to the methods described in the above embodiments. For example, a configuration in which when playback is allowed, information that a playback allowance flag for ABC_BD is on is recorded in the memory 105 of the control section 103, and when playback is not allowed, information that a playback prohibition flag for ABC_BD is on is recorded in the memory 105 of the control section 103 may be used. In this configuration, a check method in which in the step S204, the control section 103 refers to the memory 105 to check whether the playback allowance flag is on or off, and whether the playback prohibition flag is on or off may be used.

In a situation where there are information recording mediums such as an optical disc, etc., in different formats, according to the present disclosure, a playback apparatus and a playback method, etc. in which whether there is any relevance between contents having video data in different formats is identified, and when there is relevance between the contents, the video data is played back can be provided.

What is claimed is:

1. An apparatus for playing back first video data, the apparatus comprising:
a read section configured to read out information from an information recording medium; and
a control section configured to control the read section,
wherein
a first content includes first information and the first video data,
a second content includes second information and second video data recorded in a different format from a format of the first video data,
the first information is a part of management information for third video data recorded in a different format from the format of the first video data,
the second information is a part of management information for the second video data,
the read section reads out the first information and the second information from the first content and the second content, respectively, and outputs the first information and the second information to the control section, and
when the first information and the second information match, the control section plays back the first video data.

2. The apparatus of claim 1, wherein
when the first information and the second information do not match, the control section does not play back the first video data.

3. The apparatus of claim 1, wherein
when the second video data and the third video data are the same, the first information and the second information match.

4. The apparatus of claim 1, wherein
the first video data has higher image quality than image quality of the second video data.

5. The apparatus of claim 1, wherein
the first content and the second content are recorded in a first information recording medium and a second information recording medium, respectively.

6. The apparatus of claim 1, wherein
the control section includes a recording section.

7. The apparatus of claim 6, wherein
when the first information and the second information match, the control section records, in the recording section, playback allowance information indicating that playback of the first video data is allowed.

8. The apparatus of claim 7, wherein
when the playback allowance information is recorded in the recording section, the control section controls the read section so that the read section does not read out the first information and the second information, and plays back the first video data.

9. The apparatus of claim 6, wherein
the control section records the second information in the recording section.

10. The recording apparatus of claim 9, wherein
the read section reads out the first information from the first content, and outputs the first information to the control section, and
when the first information and the second information recorded in the recording section match, the control section controls the read section so that the read section does not read out the second information from the second content, and plays back the first video data.

11. The recording apparatus of claim 10, wherein
the first content and the second content are recorded in a first information recording medium and a second information recording medium, respectively.

12. A method for playing back first video data using a playback apparatus,
a first content including first information and the first video data,
a second content including second information and second video data recorded in a different format from a format of the first video data,
the first information being a part of management information for third video data recorded in a different format from the format of the first video data, and
the second information being a part of management information for the second video data,
the method comprising:
comparing the first information read out from the first content and the second information read out from the second content, and
causing, when the first information and the second information match, playback of the first video data.

13. The method of claim 12, wherein
when the first information and the second information do not match, the first video data is not played back.

14. The method of claim 12, wherein
when the second video data and the third video data are the same, the first information and the second information match.

15. The method of claim 12, wherein
the first video data has higher image quality than image quality of the second video data.

16. The method of claim 12, wherein
the first content and the second content are recorded in a first information recording medium and a second information recording medium, respectively.

17. A program for playing back first video data,
wherein
a first content includes first information and the first video data,
a second content includes second information and second video data recorded in a different format from a format of the first video data,
the first information is a part of management information for third video data recorded in a different format from the format of the first video data,
the second information is a part of management information for the second video data, and
the program compares the first information read out from the first content and the second information read out from the second content, and
causes, when the first information and the second information match, playback of the first video data.

18. The program of claim 17, wherein
when the first information and the second information do not match, the program does not cause playback of the first video data.

19. The program of claim 17, wherein
when the second video data and the third video data are the same, the first information and the second information match.

20. The program of claim 17, wherein
the first video data has higher image quality than image quality of the second video data.

21. The program of claim 17, wherein
the first content and the second content are recorded in a first information recording medium and a second information recording medium, respectively.

22. An information recording medium in which a first content is recorded,
wherein
the first content includes first information, first video data, and a program,
a second content includes second information and second video data recorded in a different format from a format of the first video data,
the first information is a part of management information for third video data recorded in a different format from the format of the first video data,
the second information is a part of management information for the second video data, and
the program compares the first information read out from the first content and the second information read out from the second content, and
causes, when the first information and the second information match, playback of the first video data.

23. The information recording medium of claim 22, wherein
the second content is recorded in a second information recording medium which is a different information recording medium from the information recording medium.

24. The information recording medium of claim 22, wherein
when the first information and the second information do not match, the program does not cause playback of the first video data.

25. The information recording medium of claim 22, wherein
when the second video data and the third video data are the same, the first information and the second information match.

26. The information recording medium of claim 22, wherein
the first video data has higher image quality than image quality of the second video data.

27. A semiconductor integrated circuit for playing back first video data,
wherein
a first content includes first information and the first video data,
a second content includes second information and second video data recorded in a different format from a format of the first video data,
the first information is a part of management information for third video data recorded in a different format from the format of the first video data,
the second information is a part of management information for the second video data, and
the semiconductor integrated circuit compares the first information read out from the first content and the second information read out from the second content, and
causes, when the first information and the second information match, playback of the first video data.

28. The semiconductor integrated circuit of claim 27, wherein
when the first information and the second information do not match, the semiconductor integrated circuit does not cause playback of the first video data.

29. The semiconductor integrated circuit of claim 27, wherein
when the second video data and the third video data are the same, the first information and the second information match.

30. The semiconductor integrated circuit of claim 27, wherein
the first video data has higher image quality than image quality of the second video data.

31. The semiconductor integrated circuit of claim 27, wherein
the first content and the second content are recorded in a first information recording medium and a second information recording medium, respectively.
